(19) United States
(12) Patent Application Publication
(10) Pub. No.: US 2005/0097133 A1
(43) Pub. Date: May 5, 2005

(54) Producing software distribution kit (SDK) volumes

(76) Inventors: Quoc Pham, Spring, TX (US); Valentin Popescu, Houston, TX (US); An Dao, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/699,259

(22) Filed: Oct. 31, 2003

(51) Int. Cl. G06F 7/00

(52) U.S. Cl. 707/104.1

(57) ABSTRACT

A library stores individual component files of software distribution kits (SDKs) on a file storage server. When an SDK is to be added to the library, a file extractor copies component files from SDK volume master(s) and stores the copies in the library. The library includes a database to store information about the SDKs, such as how many SDK volumes are in each SDK and which component files are in each SDK volume. The database also stores the name and version of each SDK, thereby enabling a user to browse the library and select an SDK, or an individual SDK volume, for production. An SDK builder then creates the selected SDK volume(s). The SDK builder can “burn” CDs using, for example, a CD burner connected to the user's computer or a central, high-capacity robotic CD burner.

### BACKGROUND

1. Field of the Invention

The present invention relates generally to distributing computer software and, more particularly, to producing software distribution kit (SDK) volumes.

2. Related Art

Some computer vendors preinstall software, such as operating systems and application programs, on computers before shipping the computers to users. For example, it is common for a new personal computer (PC) to be delivered with word processor, Internet browser and spreadsheet software packages already installed on the PC's hard drive. If a user wishes, he or she can install additional software on the PC. Similarly, the user can upgrade the preinstalled software, such as when a new version of one of the preinstalled software packages becomes available. In either case, the user first obtains a “software distribution kit” (SDK), which the user then uses to install or upgrade the software.

SDKs are typically obtained by downloading them, e.g. from the Internet, or by purchasing them, e.g. from computer stores or software vendors. SDKs are available in various forms. For example, a downloaded SDK typically does not have any physical components. Instead, a downloaded SDK typically consists of one or more files that are copied from an Internet site directly to a PC's hard drive. On the other hand, a purchased SDK typically contains one or more physical volumes of removable, computer-readable media (“SDK volumes”) on which the files are distributed. A collection of one or more volumes of an SDK are referred to herein as an “SDK volume set.” Compact discs (CDs) are typically used as the SDK volumes, however other media types, such as digital versatile discs (DVDs, also known as digital video discs), can also be used.

As noted, SDK volumes store various types of files that are used to install software on a computer. The first volume of an SDK typically includes an installation program or script that is executed by a computer to install the software on the computer. Often, the computer's operating system has been configured to automatically execute this program or script when the first SDK volume is inserted into an appropriate drive connected to the computer. The installation program or script typically copies some or all of the remaining files from the SDK volume(s) to the computer's hard drive. However, installing software typically involves more than merely copying files to a computer's hard drive. In some cases, the installation program modifies the files as it copies them to the computer or it integrates the files with existing files on the computer. The installation program or script typically copies selected files to the computer only if the files do not already reside on the computer's hard drive, e.g. as a result of a previous installation of an earlier version of the software package or another software package. Which files on the SDK are processed by the installation program might also depend on installation options selected by the user. For example, if the user does not require all the features that are available in a software package, the user might select a “minimum” installation, which copies only a few files from the SDK to the computer. In contrast, a “full” installation typically copies more files to the computer. Some installation programs and scripts make configuration changes to the computer to “register” the newly installed software with the operating system. In addition, an installation program typically adds icons to a computer's user interface to enable a user to start the application program, read its documentation, etc.

Software producers often experience inventory problems due to the constantly changing mix of SDKs they must keep in stock to satisfy demand for the kits. This problem occurs, in part, because software development organizations release new software, and new versions of existing software, rather frequently. Each release requires a new SDK. In addition, software development organizations often release test versions of the software before releasing production versions of the software. Each test version also requires an SDK. Once the production version of a software package is released, any existing test versions of the software generally become obsolete. However, obsolete SDKs cannot always be discarded, because occasionally some customers or software development organizations need one or more historical versions of an SDK long after the SDK has become obsolete. Predicting which historical SDKs will be needed and when they will be needed are very difficult, so it is usually not possible to keep an appropriate number of historical SDKs in stock. Furthermore, the expected useful life of media sometimes limits how long SDKs remain reliable and, therefore, how long they can be stored in inventory.

As noted, the frequent release of new production and test versions of software leads to an ever-changing mix of SDKs in a software producer's inventory. Each new software package, each revision to an existing software package and each test version of a software package requires its software producer to inventory an additional SDK. For each volume of the additional SDK, a software development organization usually provides an SDK volume “master.” A software manufacturing organization then mass-produces SDK volumes from the master volume. If the SDK includes more than one volume, the software producer packages the appropriate SDK volumes together. In any case, the SDKs are then kept in inventory. If the software producer underestimates demand for a particular software package, the software producer might have difficulty providing enough SDKs in a timely manner. In such a case, the software producer typically uses the SDK volume master(s) to mass-produce additional copies of the SDK volume(s). On the other hand, if the software producer overestimates the demand, many SDKs might ultimately have to be discarded when they become obsolete.

### SUMMARY OF THE INVENTION

In one aspect of the present invention, a system for producing a software distribution kit (SDK) volume, the SDK volume being a removable computer-readable volume storing a plurality of SDK component files, is disclosed. The system comprises at least one normalized file storage server configured to store SDK component files of a plurality of SDK volumes; and a database configured to identify the SDK component files of each SDK volume.

In another aspect of the present invention, a system for producing a software distribution kit (SDK) volume, the SDK volume being a removable computer-readable volume storing a plurality of SDK component files, is disclosed. The system comprises means for storing SDK component files of a plurality of SDK volumes; and means for identifying the SDK component files of each SDK volume.

In yet another aspect of the present invention, a method for producing a software distribution kit (SDK) volume, the SDK volume being a removable computer-readable volume storing a plurality of SDK component files, is disclosed. The method comprises for each of the plurality of SDK component files, if the SDK component file has not already been stored on a file storage server, storing the SDK component file on the file storage server; and storing in a database information correlating the stored SDK component files with the SDK volume.

In a further aspect of the present invention, a method for producing a software distribution kit (SDK) volume, the SDK volume being a removable computer-readable volume storing a plurality of SDK component files, is disclosed. The method comprises copying the plurality of SDK component files from a file storage server; creating an image of the SDK volume from the copied SDK component files; and writing the image to a writeable removable computer-readable volume.

### BRIEF DESCRIPTION OF THE DRAWINGS

FIG. 1 is a block diagram of an exemplary hardware environment in which a library and other aspects of one embodiment of the present invention can be practiced.

FIG. 2 is a block diagram of functional components, including a database, of one embodiment of the library of FIG. 1.

FIG. 3 contains a simplified diagram of relationships among records stored in the database of FIG. 2, according to one embodiment of the present invention.

FIG. 4 is a simplified diagram of the layout of a data compact disc (CD), such as a software distribution kit (SDK) master that might be read by, and added to, the library of FIGS. 1 and 2, according to one embodiment of the present invention.

FIG. 5 shows a simplified schema for a portion of the database of FIGS. 2 and 3, according to one embodiment of the present invention.

FIG. 6 shows a simplified schema for another portion of the database of FIGS. 2 and 3, according to one embodiment of the present invention.

FIG. 7 contains a simplified flowchart showing how an SDK master can be added to the library of FIGS. 1 and 2, and how records can consequently be added to the database of FIGS. 5 and 6, according to one embodiment of the present invention.

FIG. 8 illustrates an simplified exemplary job file that can be used to communicate between functional components of the library of FIGS. 1 and 2, according to one embodiment of the present invention.

FIGS. 9A and 9B contain a simplified flowchart showing how a functional component of the library of FIGS. 1 and 2 processes the job file of FIG. 8, according to one embodiment of the present invention.

FIGS. 10A and 10B contain a simplified flowchart that shows how an SDK or one volume of an SDK can be created, according to one embodiment of the present invention.

FIG. 11 contains a simplified flowchart that shows how an SDK or one volume of an SDK can be created, according to another embodiment of the present invention.

### DETAILED DESCRIPTION

The present invention is directed to producing software distribution kit (SDK) volumes where and when they are needed, thereby minimizing the need to inventory physical SDKs volumes in anticipation of a demand for the SDKs. As noted, SDKs comprise one or more SDK volumes, each of which contains various component files. In one embodiment, individual component files are stored in a library on a file storage server. When an SDK is added to the library, component files from SDK master(s) are copied to the library. The library also includes a database to store information about the SDKs, such as how many SDK volumes are in each SDK and which component files are in each SDK volume. In certain embodiments, the database also stores the name and version of each SDK, thereby enabling a user to browse the library and select an SDK, or an individual SDK volume, for production. The information contained in the database is then used to create an SDK containing the selected SDK volume(s). The SDK is provided on a computer-readable medium, such as a CD.

To prevent storing unnecessary copies of component files, the library preferably stores one copy of each unique component file. Such “normalized” storage of component files saves storage space because some SDK volumes contain files that are identical in content (not necessarily in name) to files contained in other SDK volumes. This is especially true of successive versions of a single software package, because many files remain unchanged from version to version of a software package. In addition, it is common for SDKs to include prerequisite software, such as run-time libraries. Many software packages require the same run-time libraries as other software packages, so SDKs for these software packages typically contain some redundant component files. Consequently, when SDK masters are added to the library, it is likely that copies of some of their component files have already been stored in the library. Optionally, data stored in the library can be compressed to further save storage space.

For simplicity, the invention is described with reference to CDs, but the invention also applies to any computer-readable medium or combination of media on which SDKs can be distributed. The media need not be read-only media, as long as SDKs can be produced on the media. For example, recordable DVDs (DVDRs) and DVD burners or ZIP disks and ZIP drives can be used to practice the invention. Therefore, in describing the present invention, the terms “SDK volume,” “CD,” “CD volume,” “SDK volume set” and “CD set” mean any appropriate medium or combination of media.

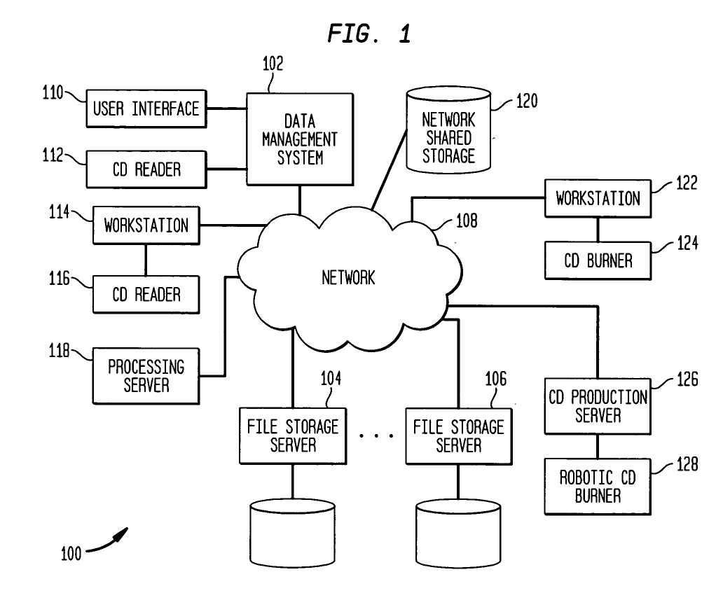

FIG. 1 is a block diagram of an exemplary hardware environment in which aspects of the present invention can be practiced. In one embodiment, a library 100 comprises a data management system 102 connected to a plurality of replicating file storage servers 104-106 via a computer network 108. The file storage servers 104-106 store SDK component files that have been added to library 100. A user interface 110, such as a monitor, keyboard and mouse, enables a software librarian or other administrator to interact with data management system 102 and, thereby, instruct the data management system 102 to add SDKs to library 100, delete SDKs from library 100, display usage statistics, authorize users of the system, etc.

The administrator can, for example, mount an SDK volume master on a CD reader 112, so component files of the SDK volume master can be copied to one of the file storage servers 104-106. Alternatively, the administrator can use a workstation 114 to communicate with data management system 102 via network 108 and, thereby, interact with the data management system. The administrator can, for example, use a CD reader 116 connected to workstation 114 to mount an SDK volume master and add it to library 100.

In one embodiment, a processing server 118 and network shared storage 120 are included in library 100 to facilitate processing an SDK volume master. In one embodiment, data management system 102 instructs processing server 118 to process the SDK volume master. Data management system 102 communicates with processing server 118 through network shared storage 120. For example, management system 102 can send processing server 118 the name of an SDK and a path to a device, such CD reader 112 or 116, on which the SDK volume master is mounted. Processing server 118 reads the SDK volume master and copies appropriate component files, e.g., normalized files, to one of the file storage servers 104-106. Processing server 118 also creates database records on one of the file storage servers 104-106 to reflect the added SDK volume.

A user, e.g. of a workstation 122, can communicate with data management system 102 via network 108 to request that an SDK volume or volume set be produced. In one embodiment, the appropriate component files are copied from the file storage server 104-106 that is nearest workstation 122 on network 108. The files are then written to a CD on a local CD burner 124 connected to the workstation 122. Alternatively, workstation 122 can send a command to a CD production server 126 to produce the SDK volume or volume set. In this case, CD production server 126 can fetch the component files from workstation 122 or the nearest file storage server 104-106 and use a robotic CD burner 128 to burn one or more copies of the SDK volume or volume set.

The embodiment of library 100 illustrated in FIG. 1 includes a plurality of replicating file storage servers 104-106. However, other embodiments can use a single, non-replicating file storage server (not shown). The number of replicating file storage servers 104-106, and the geographic location of each of the servers, depend on several factors, such as the anticipated load on the system and the geographic distribution of the users. File storage servers 104-106 automatically replicate the component files and database records stored therein, as described in more detailed in commonly-assigned U.S. Pat. Nos. 6,038,399 and 6,202,070, which are hereby incorporated by reference. Thus, to add an SDK volume to library 100, its component files and database records need to be added to only one of the file storage servers 104-106. Replication automatically copies the component files and database records to the other file storage servers 104-106.

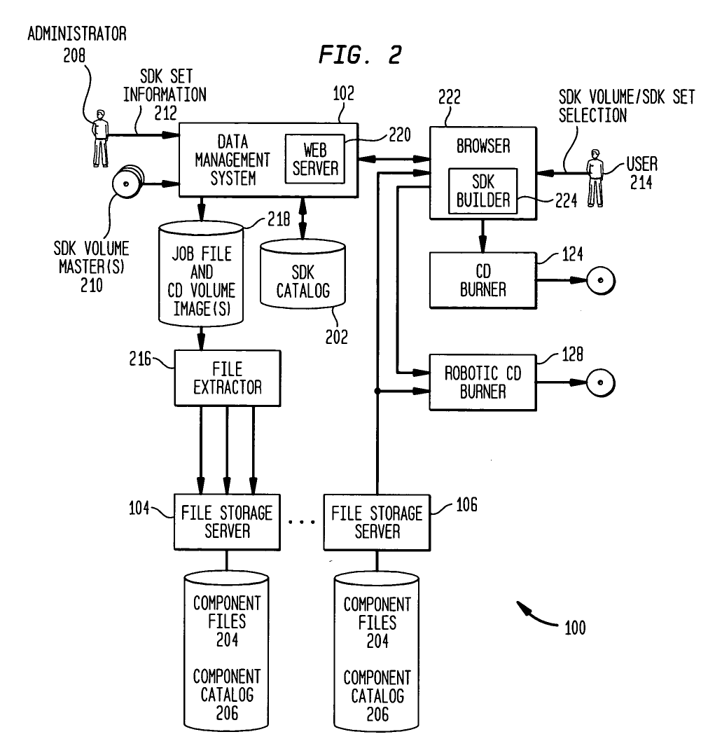

FIG. 2 is a block diagram that shows the functional components of one embodiment of library 100 and how information is stored by, and flows among, these functional components. As noted, file storage servers 104-106 store SDK component files. In one embodiment, file storage servers 104-106 and data management system 102 each stores a portion of the database that catalogs the component files and the SDKs in library 100. In this embodiment, the database is divided into two portions. One portion, referred to as SDK catalog 202, catalogs the SDKs and the SDK volumes that are stored in library 100. SDK catalog 202 is stored in data management system 102 and is available for browsing by a user 214, such as via a browser 222 on workstation 122. By browsing this portion of the database, the user 214 can select an SDK volume or volume set to be produced.

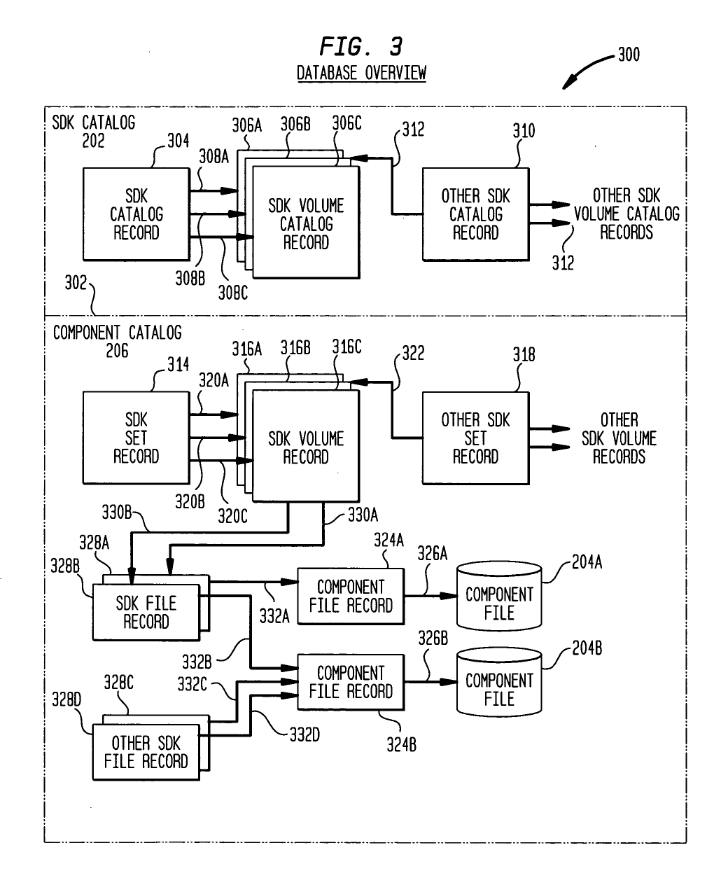

The other portion of the database, referred to as component catalog 206, catalogs the component files stored in library 100. Component catalog 206 identifies, for example, which component files make up each SDK volume and how many volumes are in each SDK volume set. In the embodiment illustrated in FIG. 2, component catalog 206 is stored in file storage servers 104-106. As one of ordinary skill in the art would find apparent, other embodiments can divide and store the database differently. Yet other embodiments can store the entire database in one place, such as data management system 102, file storage servers 104-106 or another server (not shown). A more detailed description and schema of SDK catalog 202 and component catalog 206 are provided below with reference to FIGS. 3, 5 and 6.

Automatic replication ensures that all the file storage servers contain essentially the same contents. That is, if an SDK is added to one of the file storage servers, its component files are automatically copied (replicated) to the other file storage servers. This replication enables any file storage server to fulfill any request. Such an arrangement can, for example, continue to function, even if some of the file storage servers fail. Geographically distributing the file storage servers places the servers closer to potential users, thereby reducing the time required to transfer component files from one of the file storage servers to a user's computer.

Also as previously noted, to add an SDK to library 100, an administrator 208 mounts one or more SDK volume masters 210 and enters SDK set information 212 into data management system 102, such as through user interface 110 and CD reader 112 (FIG. 1) or workstation 114 and CD reader 116 (FIG. 1). SDK set information 212 can include, for example, a description of the SDK and its version number. Data management system 102 can also read additional information about the volume master(s) directly from SDK volume master(s) 210, if necessary. Data management system 102 stores some or all of the information about the SDK and its volumes in SDK catalog 202. A user 214 can then browse SDK catalog 202 to select an SDK or an SDK volume for production, as noted above.

In one embodiment of library 100, a file extractor 216 executes on workstation 114 (FIG. 1) to copy component files from SDK volume master(s) 210 to one of the file storage servers 104-106. In one embodiment, the data management system 102 instructs file extractor 216 by writing to a job file 218 stored on network shared storage 120. File extractor 216 receives its instructions by reading job file 218. Data management system 102 can read SDK volume master(s) 210 and send image(s) of the volume master(s) along with job file 218 to file extractor 216. Alternatively, data management system 102 can send file extractor 216 a path to SDK volume master(s) 210, and the file extractor can read the volume master(s) directly. In either case, file extractor 216 creates necessary, e.g., normalized, component files 204 on one of the file storage servers 104-106. When file extractor 216 adds an SDK or an SDK volume to library 100, the file extractor creates records in component catalog 206, identifying which component file(s) 204 is/are contained in each SDK volume.

Data management system 102 includes a web server 220 that makes SDK catalog 202 available for browsing. To produce an SDK volume or volume set, user 214 uses a browser 222 in workstation 112 (FIG. 1) to browse SDK catalog 202 and select an SDK or SDK volume. Web server 220 can also download an SDK builder 224 to browser 222. SDK builder 224 can be, for example, an ActiveX component or a Java applet. Once user 214 has selected an SDK or SDK volume for production, SDK builder 224 can access component catalog 206 in the nearest file storage server 104-106 to locate component files 204 of the desired SDK volume(s). The SDK builder 224 can then copy the located component files 204 to CD burner 124. Alternatively, SDK builder 224 can send a command torobotic CD burner 128 to copy the component files from SDK builder 224 or from one of the file storage servers 104-106 and produce the requested in SDK volume(s).

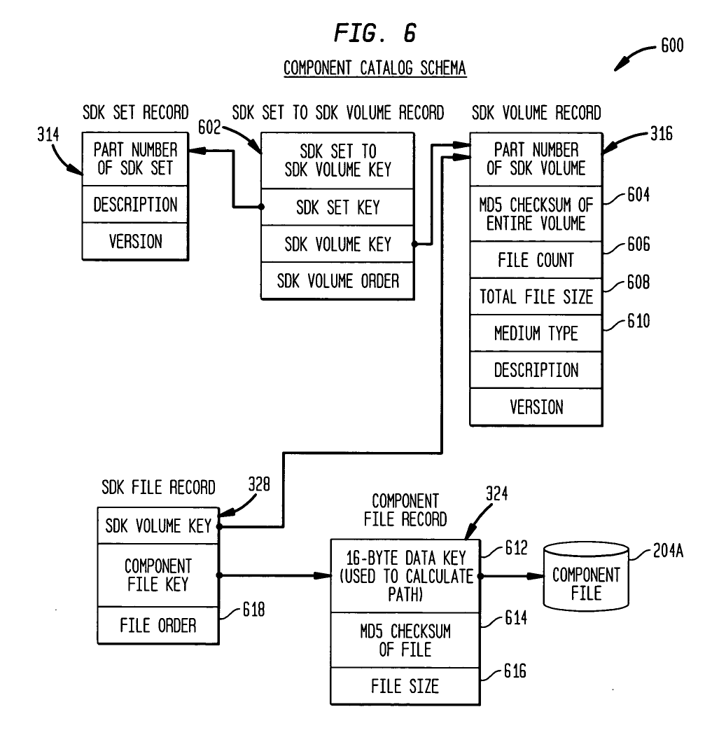

The two portions of the database, SDK catalog 202 and component catalog 206, are described below with reference to FIGS. 3, 5 and 6. An overview of SDK catalog 202 and component catalog 206 will first be described with reference to FIG. 3. A more detailed schema of these catalogs is described below, in conjunction with FIGS. 5 and 6.

As will become evident from the description of the two catalogs 202 and 206, they are functionally somewhat redundant, and in other embodiments they could be combined into one catalog. However, SDK catalog 202 is preferably stored separate from component catalog 206 to provide faster access to the SDK catalog, especially by users browsing the SDK catalog. As would be appreciated by one of ordinary skill in the art, computer systems can be “tuned” to perform various functions. For example, data management system 102 can be tuned to optimize database performance, and file storage servers 104-106 can be tuned to optimize file service performance.

FIG. 3 is a simplified diagram of relationships among records stored in SDK catalog 202 and component catalog 206. Collectively, these two catalogs comprise a database 300. For ease of illustration, a dashed line 302 separates the SDK catalog 202 from the component catalog 206. Records in database 300 represent SDKs and SDK volumes. These records store respective part numbers of the SDKs and SDK volumes. Thus, it is possible to search database 300 for a particular SDK part number. Depending on other information, such as language, product name, etc., stored in the records, it can also be possible to search database 300 for an SDK or SDK volume according to this other information. If a search returns multiple matching records, the library can present the matching records for a user to select. As described in detail below, once a record representing a desired SDK is found, records representing its constituent SDK volumes can also be found. Similarly, it is possible to search database 300 for a particular SDK volume part number. Once a record representing a desired SDK volume is found, records representing its constituent component files can be found. In addition, once a record representing the desired SDK volume is found, is possible to find the record(s) representing SDK(s) that include this SDK volume.

SDK catalog 202 catalogs the SDKs and SDK volumes in the library 100. For each SDK, SDK catalog 202 contains an “SDK catalog record” 304 (FIG. 3). For each SDK volume, SDK catalog 202 contains an “SDK volume catalog record” 306A, 306B and 306C. Each SDK catalog record 304 is linked to its constituent SDK volume catalog record(s) 306, as illustrated by arrows 308A, 308B and 308C. As will be described below with reference to the schema diagram of SDK catalog 202 (FIG. 5), links 308 can be used to traverse database 300 from one type of record to another type of record. Thus, if a user browsing SDK catalog 202 locates an SDK of interest, the user can obtain information about the SDK volumes that make up the SDK. Conversely, if the user locates an SDK volume of interest, the user can obtain information about the SDK(s) that the SDK volume is a member of.

Preferably, database 300 normalizes information about SDK volumes. That is, if two or more SDKs include a common SDK volume, database 300 contains only one record 1306 to represent the SDK volume. This is illustrated in FIG. 3 by a second SDK catalog record 310 representing a second SDK that includes one SDK volume in common with the SDK represented by SDK catalog record 304. In this illustrative example, the common SDK volume is represented by SDK volume catalog record 306B. The second SDK catalog record 310 is linked to the common SDK volume catalog record 306B, as shown by arrow 312. Thus, both SDK catalog records 304 and 310 are linked to SDK volume catalog record 306B. The second SDK catalog record 310 is also linked to other SDK volume catalog records not shared with SDK catalog 304, as represented by arrows 312.

With continued reference to FIG. 3, component catalog 206 catalogs component files 204, as noted above. In the example shown in FIG. 3 component catalog 206 includes two normalized (unique) component files 204A and 204B. For each component file 204A, 204B, component catalog 206 contains a component file record 324A and 324B, respectively. Among other information, component file records 324 contains paths, represented by arrows 326A and 326B, to the respective component files 204 on file storage servers 104-106.

In the embodiment illustrated in FIG. 3, component catalog 206 also includes records that represent SDKs and SDK volumes, which are accessed by SDK builder 224 and robotic CD burner 128 as described below, include SDK set record 314 and 318, SDK volume records 316A-C, together with linking arrows 320A-C and 322. These records and links represent the same SDKs and SDK volumes as corresponding records in SDK catalog 202, as described above. When an SDK is added to library 100, data management system 102 (FIG. 2) creates an SDK catalog record 304 and SDK volume catalog record(s) 306, as well as link(s) 308. Similarly, when an SDK is added to library 100, file extractor 216 (FIG. 2) creates an SDK set record 314 and SDK volume record(s) 316, as well as link(s) 320.

Each SDK volume contains one or more component files 206, each represented by an SDK file record 328A and 328B. As shown by arrows 330A and 330B, an SDK volume record 316C is linked to its corresponding SDK file record(s) 328. Furthermore, each SDK file record 328 is linked to its corresponding component file record 324, as represented by arrows 332. Thus, if an SDK volume record 316 can be identified, its constituent component file(s) 204 can be located on file storage servers 104-106. Similarly, if an SDK set record 314 can be identified, its constituent SDK volume records 316 can be located. These records and links are used by SDK builder 224 (FIG. 2) and robotic CD burner 128 to locate component files 204 when producing an SDK volume.

If two or more SDK volumes include a common component file 204, each of the SDK volume has its own SDK file record 328, because the component file might appear at a different location on each of the SDK volumes. This situation is illustrated in FIG. 3. Two other SDK volumes include component file 204B. Each of these other SDK volumes has a corresponding SDK file record 328C and 328D. These SDK file records 328C and 328D are linked, as indicated by arrows 332C and 332D, to the common component file record 324B. The three SDK volumes do not share a common SDK file record 328, because the SDK file record indicates the order in which its corresponding file should appear on the SDK volume, and component file 204B can appear at a different location in each of the three SDK volumes. Thus, a component file record 324 represents a component files 204 stored in library 100, while an SDK file record 328 represents a component file of an SDK volume.

When an SDK volume is added to library 100, file extractor 216 (FIG. 2) creates a component file record 324 for each component file 204 copied from the SDK volume master 210 (FIG. 2) to one of the file storage servers 104-106. File extractor 216 creates an SDK file record 328 for each file on the SDK volume master 210, regardless of whether the file is copied to the file storage server 104-106 or not.

The records in database 300 that represent SDKs and SDK volumes store respective part numbers for the SDKs and SDK volumes. Thus, it is possible to search SDK catalog records 304 or SDK set records 314 for a particular SDK part number. As previously noted, once the record representing a desired SDK is found, records representing its constituent SDK volumes can also be found. Similarly, it is possible to search SDK volume catalog records 306 or SDK volume records 316 for a particular SDK volume part number. Once the record representing a desired SDK volume is found, records representing its constituent component files can be found. In addition, once the record representing the desired SDK volume is found, is possible to find the record(s) representing SDK(s) that include this SDK volume.

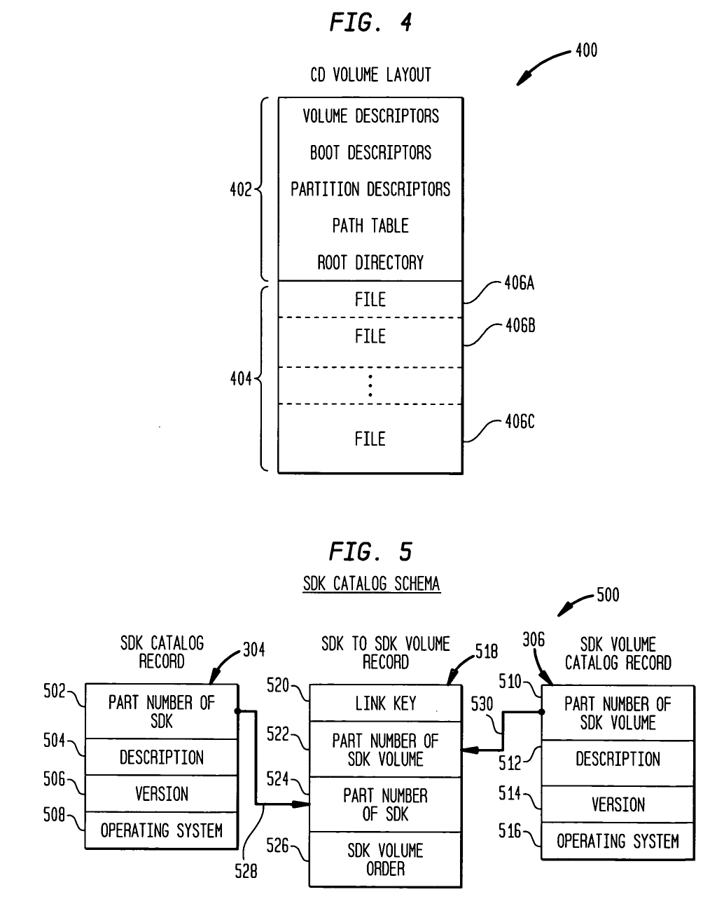

As previously noted, when an SDK is added to library 100, file extractor 216 reads SDK volume master(s) 210 and copies unique files from the volume master to one of the file storage servers 104-106. A brief description of the layout of one embodiment of a CD volume is provided below to facilitate understanding how file extractor 216 operates. FIG. 4 is a simplified diagram 400 of the layout of a data CD, according to ISO standard 9660. A first portion 402 of the CD contains various data, such as volume descriptors, boot descriptors, partition descriptors, a path table and a root directory. Information stored in the first portion 402 of the CD is referred to herein as “header information.” Other media types, such as DVDs, have logically equivalent layouts and logical equivalents to the header information. A second portion 404 of the CD contains files 406A, 406B and 406C. Each of the files 406 begins on a sector boundary.

When file extractor 216 reads an SDK volume master 210, it treats the header information 402 of the volume master as a file. If the file storage servers 104-106 do not already store a component file 204 with the same contents as the header information 402 of the CD, file extractor 216 creates a new component file 204 and copies the header information to one of the file storage servers 104-106. Thus, file extractor 216 creates a new component file 204. In addition, file extractor 216 creates an SDK file record 328 and a component file record 324 to correspond to the newly created component file 204. On the other hand, if the contents of an existing component file 204 is identical to the header information 402 of the CD, file extractor 216 creates an SDK file record 328 and links the SDK file record to the existing component file record 324 that represents the existing component file. If an existing component file 204 is identical in contents to the header information 402 of the CD, it is likely that remaining contents 404 of the CD are also already stored in component files on file storage servers 104-106. In either case, file extractor 216 links the newly created SDK file record 328 with the appropriate SDK volume record 316.

Similarly, file extractor 216 examines each file 406 in the second portion 404 of the CD to determine if the contents of the file is the same as that of the component files 204 currently on the file storage servers 104-106. If the file storage servers 104-106 do not already store a component file 204 with the same contents as the file 406, file extractor 216 creates a new component file 204 by copying the file 406 from the CD to one of the file storage servers. File extractor 216 also creates an SDK file record 328 and a component file record 324 to correspond to the newly created component file 204. On the other hand, if an existing component file 204 is identical in contents to the file 406, file extractor 216 creates an SDK file record 328 and links the SDK file record to the existing component file record 324 that represents the existing component file. In either case, file extractor 216 links the newly created SDK file record 328 with the appropriate SDK volume record 316.

Storing the first portion 402 of the CD as a component file 204 on file storage servers 104-106 facilitates later producing an SDK volume. For example, SDK builder 224 need not be concerned about the file structure of the CD, component file names, attributes, etc., because the root directory and other file structure overhead data stored in the first portion of the CD 402 will be written to the beginning of the newly created SDK volume.

Component files 204 on file storage servers 104-106 are not necessarily given the same names as files on SDK volume master 210, from which they are copied. Instead, when file extractor 216 creates a component file 204, the file extractor generates a unique filename for the component file. For example, many SDK volumes include files named “SETUP.EXE,” but the contents of these files are likely to vary from SDK volume to SDK volume. Generating file names for component files 204 avoids filename collisions and confusion about the contents of the component files.

An overview of database 300 is provided above in conjunction with FIG. 3. Here, a description of a schema for SDK catalog 202 and component catalog 206 is provided, with reference to FIGS. 5 and 6. Catalogs 202 and 206 are preferably implemented by a relational database, such as Microsoft SQL Server, which is available from Microsoft Corp., Redmond, Wash. As is well known in the art, in a relational database, information is stored in records. Each type of record is implemented as a table of records. Each record is implemented as a row of the table. Each field of a record is implemented as a column in the table. Each record has a key that is unique among records of that table. Tables can be sorted or filtered according to one or more columns. Records in a first table can be related to records in a second table by storing a key to the second table in a field of the first table.

FIG. 5 shows a schema 500 for SDK catalog 202. As previously noted, an SDK catalog record 304 (FIG. 3) represents one SDK. Each SDK catalog record 304 preferably includes four fields: a part number of the SDK 502; a description 504 and a version number 506 of the SDK; and, if the SDK is operating system specific, an operating system identifier 508. Administrator 208 can enter the part numbers, or data management system 102 can automatically assign the part numbers.

Description field 504 can include, for example: a text name for the software package distributed by the SDK; an indication of whether the SDK contains a test or production version of the software package; and the SDK's release date and and-of-life date. Other fields can, of course, be added to SDK catalog record 304 to meet business needs of library 100, such as to keep track of which software engineering organization contributed an SDK or how many copies of the SDK were produced by the library.

An SDK volume catalog record 306 represents one SDK volume. Each SDK volume catalog record 306 preferably includes four fields: a part number of the SDK volume 510; a description 512 and a version number 514 of the SDK volume; and an operating system identifier 516, if the SDK volume is operating system specific. The SDK volume part number field 510 is the key field for the SDK volume catalog table. Of course, other fields can be added to SDK volume catalog record 306 to meet business needs of library 100.

Because there can be a many-to-many relationship between SDKs and SDK volumes, SDK-to-SDK volume records 518 are used to link the two types of catalog records 304 and 306, as is well-known in the art. Each SDK-to-SDK volume record 518 preferably includes four fields: a link key 520 (containing a system-generated unique key); a part number of SDK volume 522; a part number of SDK 524; and an SDK volume order field 526 (explained below). Other fields can, of course, be added.

As noted above, and as is well-known in the art, records in one table can be related to records in another table by keys. This is illustrated by arrows 528 and 530. Thus, linking record 518 is related to a particular SDK catalog record 304 by storing the SDK's part number in field 524. Similarly, the linking record 518 is related to a particular SDK volume catalog record 306 by storing the SDK volume's part number in field 522.

Because an SDK can include several volumes, one SDK catalog record 304 can be associated with several SDK volume catalog records 306. This is illustrated in FIG. 3, where one SDK catalog record 304 is associated with several SDK volume catalog records 306. Returning to FIG. 5, in such a situation, database 300 would include a linking record 518 for each such association. Note that each SDK volume would have a unique SDK volume part number stored in its corresponding record field 510. SDK volume order field 526 can be used to specify the order in which each SDK volume is placed in the SDK.

As is well known in the relational database art, collections of table rows, i.e. subsets of records, can be formed by querying or filtering a table by one or more criteria. For example, all SDK volume catalog records 306 associated with a particular SDK can be identified by querying the linking table 518 for all records that contain the SDK's part number in field 524. The resulting linking records 518 can then be sorted by their SDK volume order fields 526 to produce an ordered list. Then, the SDK volume part number fields 522 can be read from this ordered list to locate the SDK volume catalog records 306. This yields records representing all the volumes of the SDK in the order in which they are to appear in the SDK.

FIG. 6 illustrates a schema 600 for component catalog 206. As previously discussed, each SDK is represented by an “SDK set record” 314, and each SDK volume is represented by an “SDK volume record” 316. These records 314 and 316 are linked by “SDK set to SDK volume” records 602. These records contain information similar to the SDK catalog records 304, SDK volume catalog records 306 and linking records 518 discussed above with reference to FIG. 5, however SDK volume records 316 preferably contain some additional fields. For example, the “MD5 checksum of entire volume” field 604 contains a checksum calculated from the entire SDK volume master 210. The “file count” field 606 and “total file size” field 608 contain information about the number of files and the total amount of space these files occupy on SDK volume master 210. These fields can be used to verify correct production of an SDK volume. The “medium type” field 610 indicates the type of medium on which the SDK volume is to be produced, such as 74-minute CD, 80-minute CD, DVD, etc. For example, when SDK builder 224 produces an SDK volume, the SDK builder can use the medium type field 610 to prompt the user to insert the correct medium. This field can also be used by robotic CD burner 128 to automatically select the correct medium. Other fields shown in schema 600 are either similar to previously described fields in schema 500 or are self-explanatory.

Each component file 204 is represented by a component file record 324. Field 612 preferably contains a unique 16-byte, system-generated data key. Alphanumeric characters are used for the bytes. The data key is used to calculate a path to the component file 204A. File extractor 216, SDK builder 224 and robotic CD burner 128 can use this path to access the component file 204, as follows. The data key is preferably divided by slashes into two- and four-character segments in a 4-4-4-2-2 pattern. The name of one of the file storage servers 104-106 and a device name, for example “\\fileserver27\d$\,” are prepended to the resulting string. Then, “.dat” is appended to the string. Thus, for example, “0123456789101112” becomes “\\fileserver27\d$\0123\4567\8910\11\12.dat.” Dividing the data key in this fashion distributes component files 204 across plural directories and ensures that no single directory is overburdened.

As previously noted, when file extractor 216 processes SDK volume master 210, the file extractor creates component files on file storage servers 104-106, but only for unique files. Rather than actually comparing the contents of each file on SDK volume master 210 with every file on file storage servers 104-106, file extractor 216 calculates a “signature” for each file on the volume master. Each component file record 324 contains a signature of its corresponding component file 204. File extractor 216 compares the signatures of the files on SDK volume master 210 to the signatures stored in component file records 324 to determine if the respective files contain identical contents. The signature is preferably a combination of an MD5 checksum of the file and the file's size. Thus, each component file record 324 includes a “MD5 checksum of file” field 614 and a “file size” field 616. The MD5 checksum and file size fields 614 and 616 can also be used by SDK builder 224 or robotic CD burner 128 to verify that a CD burner operation completed without error.

As previously discussed, SDK file records 328 link SDK volume records 316 with component filed records 324. A “file order” field 618 indicates the order in which component file 204A is to be copied to the produced SDK volume.

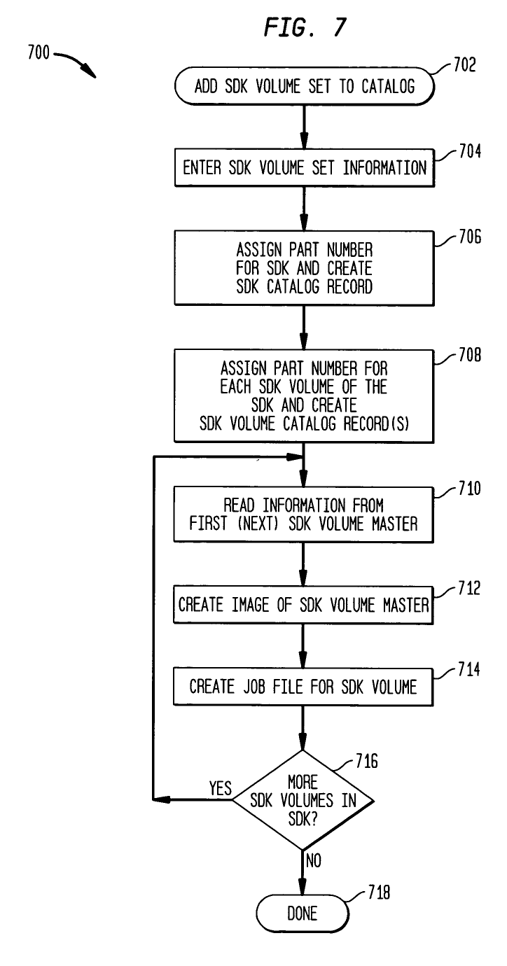

Descriptions of the database 300 and functional components of the library 100 are provided above. Additional information about file storage servers 104-106, database 300, data management system 102, normalization and replication are provided in commonly-owned U.S. Pat. Nos. 6,202,070 and 6,038,399, both of which are hereby incorporated by reference herein. A description of a procedure for adding an SDK to the library is provided here with reference to FIG. 7. The procedure collects information about the SDK, creates records in the database and creates a job file that causes the file extractor to copy unique files from an SDK volume master to the file storage servers. When a record is created, it is linked to appropriate other records, such as by filling in a part number or other “foreign key” field, as is well-known in the art.

FIG. 7 contains a flowchart 700 showing how an SDK can be added to the library. The flowchart 700 begins at 702. At 704, information about the SDK volume set is collected. The collected information can include a description of the SDK and the number of volumes in the SDK. At 706, a part number is assigned to the SDK and an SDK catalog records is created. The SDK part number can be entered by an administrator, or it can be automatically generated. At 708, for each SDK volume of the SDK, a part number is assigned and an SDK volume catalog record is created. The SDK volume part number can be entered by an administrator, or it can be automatically generated. In addition, an SDK to SDK volume linking record 518 is created. As previously noted, such linking records enable identifying the SDK volumes of an SDK. They also enable identifying the SDK, to which an SDK volume belongs. This can be useful if, for example, a user needs to obtain an entire SDK, but the user knows the part number of only one volume of the SDK volume set.

At 710, the flowchart 700 begins a loop that is processed once for each SDK volume master of the SDK. At 710, information is read from an SDK volume master. This information can be used to augment the SDK or SDK volume records. At 712, an image copy of the SDK volume master is created, so later, individual files of the SDK volume master can be extracted. The image copy can be stored, for example, on network shared storage. At 714, a job file is created for this SDK volume. Alternatively, instead of creating an image of the SDK volume master at 712, a path to the mounted SDK volume master can be included in the job file created at 714.

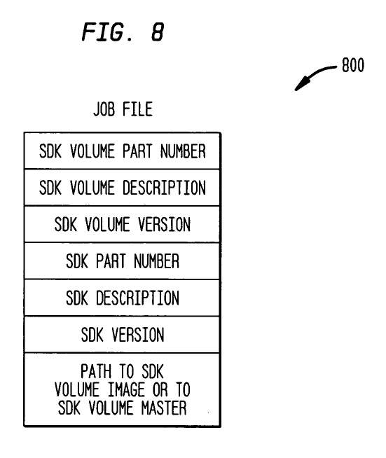

FIG. 8 illustrates an exemplary job file 800. Fields of the job file 800 contain contents similar to those of records representing SDKs and SDK volumes, as described with reference to FIGS. 5 and 6. Returning to FIG. 7, at 716, if there are more SDK volumes in the SDK, control returns to 710, otherwise the flowchart completes at 718.

The file extractor 216 (FIG. 2) copies unique files from the SDK volume master 210, or its image, to a file storage server 104-106. The file extractor 216 preferably remains dormant and periodically executes to check for the existence of a job file 218, such as on network shared storage 120 (FIG. 1). If the file extractor 216 finds a job file 218, it opens the job file and processes it. The file extractor 216 then preferably checks for another job file 218. If the file extractor 216 finds no additional job files, it returns to hibernating.

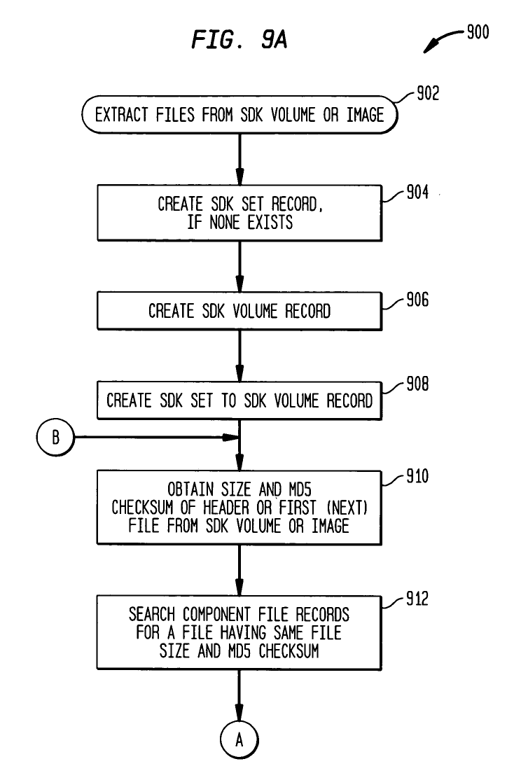

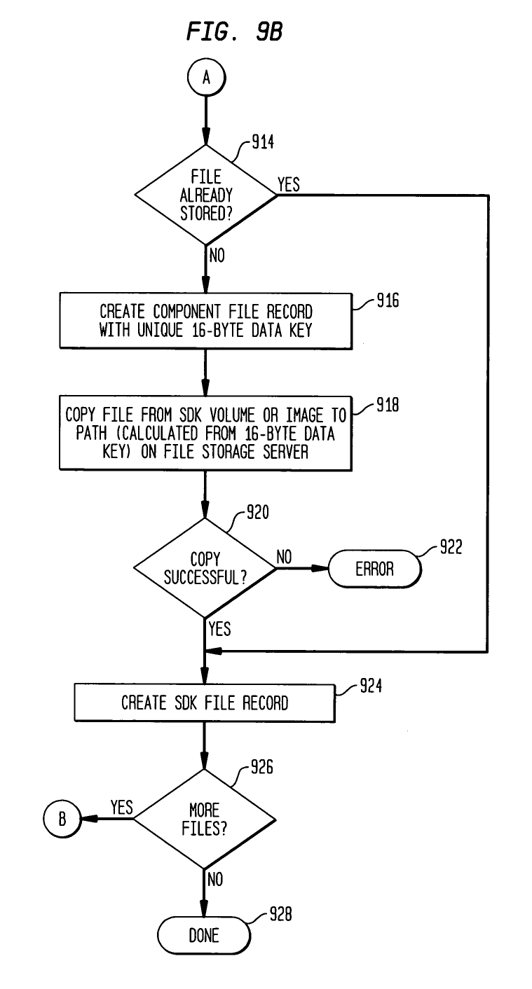

FIGS. 9A and 9B contain a flowchart 900 showing how the file extractor processes job file 800. The flowchart 900 begins at 902. At 904, an SDK set record is created, if one had not already been created, i.e. as a result of processing a previous volume of this SDK. At 906, an SDK volume record is created. At 908, an SDK set to SDK volume linking record is created. The flowchart 900 then begins a loop that is processed once for the header information on the SDK volume master and once for each file on the SDK volume master.

At 910, an MD5 checksum is calculated for a file of the SDK volume master. In addition, the size of the file is obtained. The MD5 checksum and file size are used as a signature of the file. The first time through this loop, header information, instead of a file, on the SDK volume master is processed. At 912, a search is made of the component file records for a component file having a signature identical to the file (or header information) on the SDK volume master.

At 914, if an identical signature is found, indicating that an identical file is already stored in the library, control passes to 924. Otherwise, at 916, a component file record is created with a unique 16-byte data key. At 918, the file is copied from the SDK volume master to a path calculated from the 16-byte data key, as described above. At 920, if the copy is successful, control passes to 924. Otherwise, an error is indicated at 922. Success of the copy operation can be gauged by, for example, calculating an MD5 checksum and size of the component file and comparing these values to corresponding values for the file that was copied from the SDK volume master. At 924, an SDK file record is created. At 926, if more files remain to be processed on the SDK volume master, control returns to 910. Otherwise, the flowchart completes at 928.

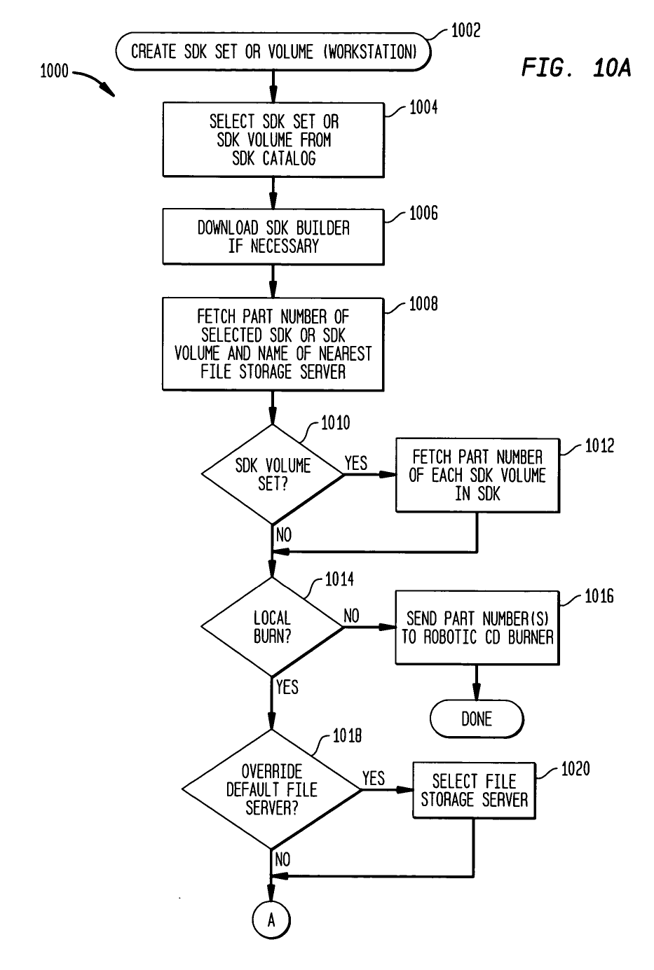

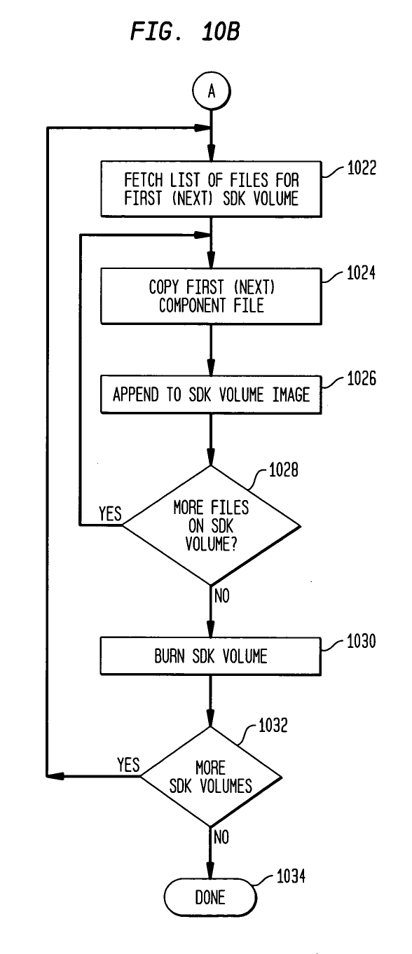

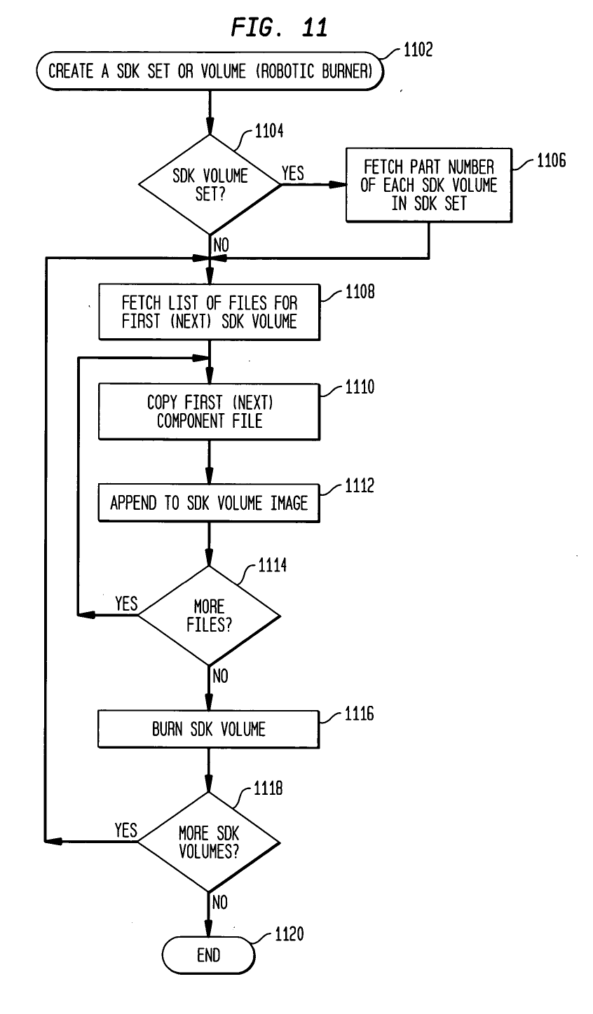

Procedures for creating an SDK, i.e. an SDK volume set, or a single SDK volume will now be described. FIGS. 10A and 10B contain a flowchart 1000 that shows how an SDK or SDK volume can be created on a workstation. Another flowchart, one that shows how the SDK or SDK volume can be created using a central robotic CD burner, is described below with reference to FIG. 11.

In FIG. 10A, the flowchart 1000 begins at 1002. At 1004, an SDK volume set or an SDK volume is selected from the SDK catalog. For example, a user could browse the SDK catalog and select an SDK or an SDK volume. Optionally, the user can also specify a number of copies of the SDK or SDK volume to produce. At 1006, the SDK builder is downloaded, if necessary. At 1008, the part number of the selected SDK or SDK volume is obtained from the SDK or SDK volume catalog record that was selected by the user. In addition, the name of the nearest file storage server is obtained. At 1010, if an entire SDK volume set is to be produced, control passes to 1012, otherwise control passes to 1014.

At 1012, the part number of each SDK volume of the SDK is obtained by filtering and sorting the SDK to SDK volume linking records. At 1014, if the SDK is not to be produced locally, control passes to 1016. At 1016, the part numbers are sent to the robotic CD burner. (Operation of the robotic CD burner is described below with reference to FIG. 11.) On the other hand, if the SDK is to be produced locally, control passes to 1018. At 1018, if the default, i.e. closest, file server is to be overridden, control passes to 1020, otherwise control passes to 1022. At 1020, a file storage server is selected.

The flowchart 1000 then begins a loop that is processed once for each volume in the SDK. At 1022, a list of files on the SDK volume is fetched by filtering and sorting the SDK file records. At 1024, one of these files is copied from the selected or default file storage server, and at 1026 the copied file is appended to an image buffer. If the file size is less than a whole multiple of the SDK volume's sector size, the file is padded to occupy a whole number of sectors. Thus, each file begins on a sector boundary of the produced SDK volume. At 1028, if more files remain, control returns to 1024. Otherwise, control passes to 1030, where the SDK volume is produced, e.g. by burning it onto a CD. At 1032, if more SDK volumes remain in the SDK volume set, control returns to 1022. Otherwise, the flowchart ends at 1034.

A user may not wish, or may not be able, to produce SDK volumes with the user's computer. For example, the user's computer might not include a CD burner, or the user might require a large number of copies of an SDK. In flowchart 1000, at 1014, a decision is made regarding producing the SDK locally, i.e. on the user's computer, or via a central robotic CD burner. If a decision is made to use the robotic CD burner, at 1016 part number(s) of the SDK or SDK volume(s) to be produced are sent to the robotic CD burner. Alternatively, each component file or the entire image buffer can be sent to the robotic burner. FIG. 11 contains a flowchart 1100 that shows how the robotic CD burner produces the SDK or SDK volume(s). The flowchart begins at 1102. At 1104, if an SDK, i.e. an SDK volume set, is to be produced, control passes to 1106. Otherwise, i.e. if a single SDK volume is to be produced, control passes to 1108. At 1106, the part number of each SDK volume of the SDK is fetched. Then the flowchart 1100 begins a loop that is processed once for each SDK volume that is to be produced.

At 1108, a list of files on the SDK volume is fetched. The flowchart 1100 then begins a loop that is processed once for each component file of the SDK volume. At 1110, a component file is copied from one of the file storage servers, preferably the file storage server nearest the robotic CD burner. At 1112, the copied file is appended to an image buffer. As described above, the copied file is padded so it occupies a whole number of sectors and begins on a sector boundary. At 1114, if there are more component files for this SDK volume, control returns to 1110, otherwise control passes to 1116. At 1116, one or more CDs are burned, depending on the number of copies of the SDK volume requested by the user. At 1118, if there are more SDK volumes in this SDK, control returns to 1108, otherwise the flowchart ends at 1120.

SDK masters that are added to the library need not be stored on the same medium/media as corresponding SDKs produced by the library. For example, SDK masters can be stored on a hard disk as images of CDs or other media when they are read by the file extractor. In addition, the SDK masters can be compressed, such as InstallShield archives or ZIP files, and the file extractor can optionally decompress the SDK masters as they are processed. SDK master, therefore, means an archive or other package of multiple files.

Some conventional computer manufacturing systems store images of hard drives that already have software installed on them. Such systems are used by computer manufacturers to preinstall software on computers before the computers are delivered to users. Such systems operate by copying an entire disk image or portions thereof to a hard drive or a partition of the hard drive, essentially installing the software on the hard drive. Thus, when a computer containing the hard drive is started (“booted”), the computer behaves as though an SDK had been installed on it.

In contrast, the present invention does not install SDKs or files on target computers. The invention provides methods and systems for producing SDKs on demand. SDKs are different than hard drives with software installed on them. As previously noted, SDKs include files, some or all of which are selectively copied to a hard drive during software installation. SDKs are not merely images of hard drives. Furthermore, SDKs typically include software installation programs or scripts that are executed by computers to install the software on the computers. In contrast, a hard disk with software preinstalled on it does not need such a software installation program. Therefore, a system that produces SDKs is different than a system that produces hard drives with software preinstalled on them.

The methods and systems for producing SDKs and other aspects of the present invention are preferably implemented in software or firmware than can be stored in a memory and control operation of a computer such as a personal computer, workstation, mainframe, control processor, or microprocessor control processor embedded in another system. The memory can, but need not, be part of a computer. Alternatively, the memory can be part of an integrated circuit that includes the control processor or microprocessor. The software or firmware can be stored on a removable or fixed computer-readable medium, such as a CD-ROM, CD-RW, DVD-ROM, DVD-RW, ZIP disk, hard disk or floppy disk. In addition, the software or firmware can be transmitted over a wireless or wired communication link, such as a public or private local or wide area computer network, including the Internet, or a telephone network.

Alternatively, the methods and systems for producing SDKs and other aspects of the present invention can be implemented in hardware. For example, the SDK builder can be implemented in a single integrated circuit or in a combination of integrated and/or discrete circuits and embedded in a network-connectable CD burner. All or portions of the methods and systems for producing SDKs can be implemented as combinatorial logic, an application-specific integrated circuit (ASIC) or a field-programmable gate array (FPGA).

1. A system for producing a software distribution kit (SDK) volume, the SDK volume being a computer-readable volume storing a plurality of SDK component files, comprising:
at least one normalized file storage server configured to store SDK component files of a plurality of SDK volumes; and
a database configured to identify the SDK component files of each SDK volume.

2. The system of claim 1, wherein:
the at least one normalized file storage server is configured to store header information for ones of the plurality of SDK volumes; and
the database is configured to identify header information for each SDK volume.

3. The system of claim 2, wherein:
the header information includes a root directory for a corresponding one of the plurality of SDK volumes.

4. The system of claim 1, wherein:
the database is configured to catalog the plurality of SDK volumes.

5. The system of claim 4, wherein:
the database configured to catalog the plurality of SDK volumes is stored on a different computer than the database configured to identify the SDK component files of each SDK volume.

6. The system of claim 1, further comprising:
a file extractor configured to copy SDK component files from a master SDK volume to at least one of the at least one normalized file storage server and add information identifying the copied SDK component files to the database.

7. The system of claim 6, wherein:
the file extractor is configured to copy header information from the master SDK volume to at least one of the at least one normalized file storage server and add information identifying the copied header information to the database.

8. The system of claim 6, wherein:
the master SDK volume is a compact disc (CD).

9. The system of claim 1, wherein the normalized file storage server is a replicating normalized file storage server.

10. The system of claim 1, further comprising:
a file extractor configured to copy SDK component files from an image of a master SDK volume to at least one of the at least one normalized file storage server and add information identifying the copied SDK component files to the database.

11. The system of claim 10, wherein:
the file extractor is configured to copy header information from the image of the master SDK volume to at least one of the at least one normalized file storage server and add information identifying the copied header information to the database.

12. The system of claim 10, wherein:
the master SDK volume is a compact disc (CD).

13. The system of claim 10, wherein:
the master SDK volume is a digital versatile disc (DVD).

14. The system of claim 1, further comprising:
an SDK builder executed by a computer other than the at least one normalized file storage server and configured to copy SDK component files of a selected one of the SDK volumes from one of the at least one normalized file storage server to a writeable computer-readable volume.

15. The system of claim 14, wherein:
the SDK builder is configured to copy header information of the selected one of the SDK volumes from one of the at least one normalized file storage server to the writeable computer-readable volume.

16. The system of claim 14, wherein:
the writeable computer-readable volume is a compact disc (CD).

17. The system of claim 14, wherein:
the writeable computer-readable volume is removable.

18. The system of claim 14, wherein:
the SDK builder is downloadable to the computer and configured to extend capabilities of a browser.

19. The system of claim 18, wherein:
the SDK builder is an ActiveX component.

20. The system of claim 1, wherein:
the SDK volume is one of a plurality of SDK volumes in an SDK volume set;
the at least one normalized file storage server is configured to store SDK component files for each SDK volume of the SDK volume set; and
the database is configured to identify each SDK volume of the SDK volume set.

21. The system of claim 20, further comprising:
a file extractor configured to, for each SDK volume of an SDK volume set, copy SDK component files from a master SDK volume to at least one of the at least one normalized file storage server and add information identifying the copied SDK component files to the database.

22. The system of claim 20, further comprising:
an SDK builder executed by a computer other than the at least one normalized file storage server and configured to, for each SDK volume of a selected SDK volume set, copy SDK component files of the SDK volume from one of the at least one normalized file storage server to a writeable computer-readable volume.

23. The system of claim 22, wherein:
the SDK builder is configured to, for each SDK volume of the selected SDK volume set, copy header information of the selected one of the SDK volumes from one of the at least one normalized file storage server to the writeable computer-readable volume.

24. The system of claim 1, wherein:
the at least one normalized file storage server is configured to store header information for the plurality of SDK volumes;
the header information includes a root directory for a corresponding one of the plurality of SDK volumes;
the database is configured to identify the header information for each SDK volume;
the database is configured to catalog the plurality of SDK volumes; and
the database configured to catalog the plurality of SDK volumes is stored on a different computer than the database configured to identify the SDK component files of each SDK volume.

25. The system of claim 24, further comprising:
a file extractor configured to copy header information and SDK component files from one of a master SDK volume and an image of a master SDK volume to at least one of the at least one normalized file storage server and add information identifying the copied SDK component files to the database.

26. The system of claim 24, further comprising:
an SDK builder executed by a computer other than the at least one normalized file storage server and configured to copy header information and SDK component files of a selected one of the SDK volumes from one of the at least one normalized file storage server to a writeable computer-readable volume.

27. A system for producing a software distribution kit (SDK) volume, the SDK volume being a computer-readable volume storing a plurality of SDK component files, comprising:
means for storing SDK component files of a plurality of SDK volumes; and
means for identifying the SDK component files of each SDK volume.

28. The system of claim 27, further comprising:
means for storing header information for ones of the plurality of SDK volumes, wherein the header information includes a root directory for a corresponding one of the plurality of SDK volumes.

29. The system of claim 28, further comprising:
means for copying header information and SDK component files from a master SDK volume to the means for storing header information and the means for storing SDK component files;
means for adding information identifying the copied SDK component files to the means for identifying the SDK component files.

30. The system of claim 29, further comprising:
means for writing header information and SDK component files of a selected one of the SDK volumes from the means for storing header information and the means for storing SDK component files to a writeable computer-readable volume.

31. The system of claim 30, wherein:
the means for writing is an ActiveX component.

32. The system of claim 31, wherein:
the writeable removable computer-readable volume is a compact disc (CD).

33. The system of claim 31, wherein:
the writeable removable computer-readable volume is removable.

34. A method for producing a software distribution kit (SDK) volume, the SDK volume being a computer-readable volume storing a plurality of SDK component files, comprising:
for each of the plurality of SDK component files, if the SDK component file has not already been stored on a file storage server, storing the SDK component file on the file storage server; and
storing in a database information correlating the stored SDK component files with the SDK volume.

35. The method of claim 34, further comprising:
if header information about the SDK volume has not already been stored on the file storage server, storing the header information on the file storage server, wherein the header information includes a root directory for the SDK volume; and
storing in the database information correlating the stored header information with the SDK volume.

36. The method of claim 34, wherein:
the SDK volume is one of a plurality of SDK volumes in an SDK volume set;
and further comprising:
storing in the database information about each SDK volume of the SDK volume set.

37. The method of claim 34, further comprising:
the stored SDK component files and the information correlating the stored SDK component files with the SDK volume header information on a second file storage server.

38. A method for producing a software distribution kit (SDK) volume, the SDK volume being a computer-readable volume storing a plurality of SDK component files, comprising:
copying the plurality of SDK component files from a file storage server;
creating an image of the SDK volume from the copied SDK component files; and
writing the image to a writeable computer-readable volume.

39. The method of claim 38, further comprising:
copying header information for the SDK volume from the file storage server, wherein the header information includes a root directory for the SDK volume;
and wherein the creating an image comprises:
creating an image of the SDK volume from the copied header information and the copied SDK component files.

40. The method of claim 39, wherein:
the writeable computer-readable volume is a compact disc (CD).

41. The method of claim 39, wherein:
the writeable computer-readable volume is removable.

42. The method of claim 39, further comprising:
selecting the file storage server based on a location of the file storage server.

43. The method of claim 38, further comprising:
downloading an SDK builder that performs the copying and creating.

44. The method of claim 38, wherein:
the SDK volume is one of a plurality of SDK volumes in an SDK volume set;
and further comprising:
performing the copying, creating and writing for each SDK volume of the SDK volume set.

45. The method of claim 38, further comprising:
sending information about the SDK volume to an SDK production server;
and wherein:
the copying, creating and writing are performed by the SDK production server.

46. The method of claim 38, wherein:
the SDK volume is one of a plurality of SDK volumes in an SDK volume set;
and further comprising:
sending information about the SDK volume set to an SDK production server;
and wherein:
the copying, creating and writing are performed by the SDK production server for each SDK volume of the SDK volume set.

47. The method of claim 38, further comprising:
sending the image of the SDK volume to an SDK production server;
and wherein:
the writing is performed by the SDK production server.
